(19) United States
(12) Patent Application Publication
(10) Pub. No.: US 2015/0247495 A1
(43) Pub. Date: Sep. 3, 2015

(54) Mechanical Device for Regulating the Flow of Fluids

(71) Applicants: Francis HENRY DE FRAHAN, (US); Raymond BRANDT, Court-Saint-Etienne (BE); Adrien DEWANDRE, Profondeville (BE)

(72) Inventors: Francis Henry De Frahan, Dorinne (BE); Raymond Brandt, Court-Saint-Etienne (BE); Adrien Dewandre, Profondeville (BE)

(21) Appl. No.: 14/438,467

(22) PCT Filed: Oct. 25, 2013
(86) PCT No.: PCT/EP2013/072440

§ 371 Date: Apr. 24, 2015

(30) Foreign Application Priority Data
Oct. 26, 2012 (BE) 2012/0739

(51) Int. Cl. F04B 43/04; F16K 99/00; F16K 31/06

(52) U.S. Cl. CPC F04B 43/043; F16K 31/06; F16K 99/0015; F16K 99/0046

(57) ABSTRACT

The invention relates to a device comprising a body or an enclosure (100) constituting at least one chamber (120, 140) with at least one inlet or fluid intake (16 or 18) and one outlet or delivery port (17) for said fluid, said device comprising at least one moving element serving as a flap (12 or 13) and making it possible to close/open the inlet and/or outlet cyclically, •-characterized in that said moving element (12 or 13) forms a body with at least one part of the body or enclosure (10) that forms the chamber of said device, •-characterized in that the nature and the mass of the moving element are such that they can be subjected to a movement under the action of an outside force.

### SUBJECT-MATTER OF THE INVENTION

The present invention relates to one or more types of mechanical devices that regulate the flow of at least one fluid.

In particular, the present invention relates to the production of a valve, sometimes called a gate, and preferably a micro-valve.

In particular, the present invention also relates to the production of a pump, and preferably a micro-pump.

### BACKGROUND OF THE INVENTION

Valves and pumps, and in particular micro-valves and micro-pumps, that have dimensions preferably smaller than cm and generally of approximately several millimeters are well known for a large number of applications.

More particularly, the applications of micro-valves and micro-pumps have seen rapid growth in particular in the biomedical field, where they may be used to transfer, sample or even extract very small quantities of fluids, and as devices allowing drug administration, for example insulin pumps, or to assist with functions, for example circulatory functions, or for outpatient measurement and monitoring of blood pressure in humans.

These micro-valves and micro-pumps may also be used for cutting-edge industrial applications, in particular in electronics (microelectronic cooling, μTAS (Total Analysis System), aeronautics, automobiles, and in particular as a cutting-edge technology for injection.

Another particularly important field that uses this type of device consists of ink injectors for printing heads.

A valve is generally defined as a mechanical device that regulates the flow of a fluid by opening and closing, or at least partially obstructing, various passageways. A valve may therefore be defined as a reservoir comprised in a valve body that has an inlet or intake and an outlet or delivery port for said fluid, the inlet and the outlet being alternatively obstructed (or closed) by at least one moving element that is generally a flap or ball.

The pumps and micro-pumps further comprise an actuator that creates a volume variation in a chamber connected to at least two ports (passageways) respectively serving as inlet or intake and outlet or delivery port for the fluid and which are opened/closed by at least one moving element such as a flap or ball. This actuator is defined as the piston, while the flaps or balls make it possible to open/close, as for the valves or micro-valves, the fluid inlet or intake and outlet or delivery port.

In the micro-valves and micro-pumps, an alternating movement is imparted to the flap or ball to open and/or close the different inlets (or intakes) and outlets (or delivery ports) of said fluid.

These flaps may be of any type. They may be formed by a simple membrane or be made up of more complex elements connected to the body of the valve or the pump and subject to a movement that may be done by any type of force, whether pneumatic, electrostatic, thermopneumatic, magnetic, etc.

It is also possible to consider using flaps assuming the form of balls for the micro-pumps and micro-valves, said flaps alternatively making it possible, through their movement, to open or close the inlet or outlet ports. Again, these balls will be subjected to the action of a pneumatic, electrostatic, thermopneumatic, magnetic, etc. force.

Furthermore, in the case of a micro-pump, the actuator (piston) will also be subjected to the action of a force that may be pneumatic, electrostatic, thermopneumatic, or even magnetic.

Typically, the forces applied to the actuator and the flaps for the micro-valves or micro-pumps are comprised between approximately 0.1 N and 20 N, preferably between approximately 1 N and approximately 5 N.

The fluid may be of any type (liquid, gaseous, single-phase or polyphase fluid).

More specifically, the micro-pumps base their operation on the operation of the typical mechanical volume displacement pumps, in which an actuator varies the volume in a chamber connected to at least two openings closed by flaps. This actuator is generally defined as the piston, while the flaps can serve as closing flaps for the inlet (or intake) or outlet (or delivery port) for a fluid. They allow the opening and closing of ports, thereby controlling the passage of a fluid.

Simply, a micro-pump or micro-valve is defined by the contents of a chamber forming the body of the micro-pump or the body of the micro-valve having a volume smaller than several cm³. In the case of a micro-pump, the actuator and the flaps typically have dimensions of approximately several millimeters.

The techniques used to produce such devices are generally etching techniques such as micro-photolithography, chemical etching, or laser or plasma etching, which are the dry etching techniques. The most traditional mechanical machining techniques may also be used.

The main difficulty lies in the miniaturization of the various elements making up the micro-valve or micro-pump, as well as the placement and securing of the various elements in the chamber or reservoir. In particular, the flap(s) and the actuator require very precise dimensioning, and the various elements must be secured very carefully.

The securing techniques are currently welding techniques, for example ultrasonic welding or micromechanical securing techniques, such as the placement of micro-pivots or micro-hinges.

### AIMS OF THE PRESENT INVENTION

The present invention aims to propose a particularly simple design that makes it possible to produce, very quickly using known techniques, (micro-) valves or (micro-) pumps that have a very small number of component parts.

In particular, the present invention aims, by reducing the number of separate component parts as much as possible, to avoid the risk of separation of certain elements.

Lastly, the present invention aims, as much as possible, to eliminate mechanical or chemical (gluing) techniques for assembling the various elements to each other.

The present invention also aims to propose the production of precision pumps that allow mixing of two or more compounds, for example for metering intended for applications to medicine, aerospace, and other cutting-edge technologies.

The present invention also aims to propose a particular design that does not require lubrication and thereby avoids any risk of pollution.

The present invention in particular aims to propose such a (micro-) valve or (micro-) pump that can be used in a sterile environment.

### BRIEF DESCRIPTION OF THE INVENTION

The present invention relates to a device as disclosed in the appended claims. The device comprises a body or an enclosure constituting or creating (encompassing, surrounding) at least one chamber with at least one inlet or fluid intake and one outlet or delivery port for said fluid, comprising at least one moving element serving as a flap and making it possible to close/open the inlet and/or outlet cyclically, characterized in that said moving element forms a body with at least one part of the body or enclosure that forms the chamber.

Preferably, the moving element is made in the form of a single piece, i.e., with no (separate) element allowing a chemical or mechanical connection with the body or enclosure of the device.

Preferably, the same moving element serving as the flap alternatively makes it possible to close or open the inlet and outlet cyclically and therefore alternatively performs both opening/closing functions for both the inlet and outlet.

Preferably, the device assumes the form of a micro-pump comprising an actuator.

Preferably, the actuator essentially assumes the form of an elongated strip or fin and also constitutes a moving element serving as a piston.

Preferably, each of the moving elements has a part serving as an integrated connection and being one with said body or said enclosure of the device. Advantageously, this part serving as an integrated connection is made so as to be able to impart a certain flexibility to said moving element so that it can move between at least two positions under the action of an outside force.

Preferably, the part serving as an integrated connection assumes the form of a circular notch.

Preferably, the form of the circular notch has an effective angle comprised between 0.02° and 20°.

Preferably, the part serving as an integrated connection is in the form of an integrated mechanical spring.

Preferably, the outside forces are of the electrostatic or magnetic type.

Preferably, the device has at least two separate chambers so as to be able to form a mixing or dosing pump.

Preferably, the volume of the different chambers is calculated so as to perform a proportional function in the mixing or final metering.

Preferably, the single piece is made from a metallic material, preferably a metal, and more particularly a ferromagnetic steel such as magnetizable stainless steel, so as to be able to be moved under the action of a magnetic field whereof the magnitude of the force is comprised between approximately 0.01 N and approximately 20 N, preferably approximately 1 N and approximately 5 N.

Preferably, the pump device has at least two separate chambers so as to be able to form a mixing or metering pump. A particular profile of the moving part will make it possible to ensure near-sealing between the chambers while leaving play of approximately 1 micron.

Preferably, the mass of the moving elements is sufficient to be able to be subjected to the electromagnetic force and has a volume of several ml.

More particularly, this device may be intended for medical applications, and in particular sterile applications.

### BRIEF DESCRIPTION OF FIGURES

FIG. 1 shows a perspective view of the micro-valve according to one embodiment of the present invention.

FIG. 2 shows a cross-sectional view of said micro-valve described in FIG. 1.

FIG. 3 shows a perspective view of a micro-pump according to one embodiment of the present invention.

FIG. 4 shows a cross-sectional view of said micro-pump described in FIG. 3.

FIG. 5 shows a cross-sectional view of a micro-pump according to another embodiment of the present invention.

### DETAILED DESCRIPTION OF THE PRESENT INVENTION

A first object relates to micro-valves whereof the general operating principle is to allow the passage of fluid through a first opening or port and to expel it through a second opening or port, each leading or directing toward passageways.

The valve may therefore be defined as a reservoir or chamber comprised in (present within) a body or enclosure that has an inlet or intake and an outlet or delivery port for said fluid, the inlet and outlet alternatively being opened and closed, at least partially, using one or more moving elements.

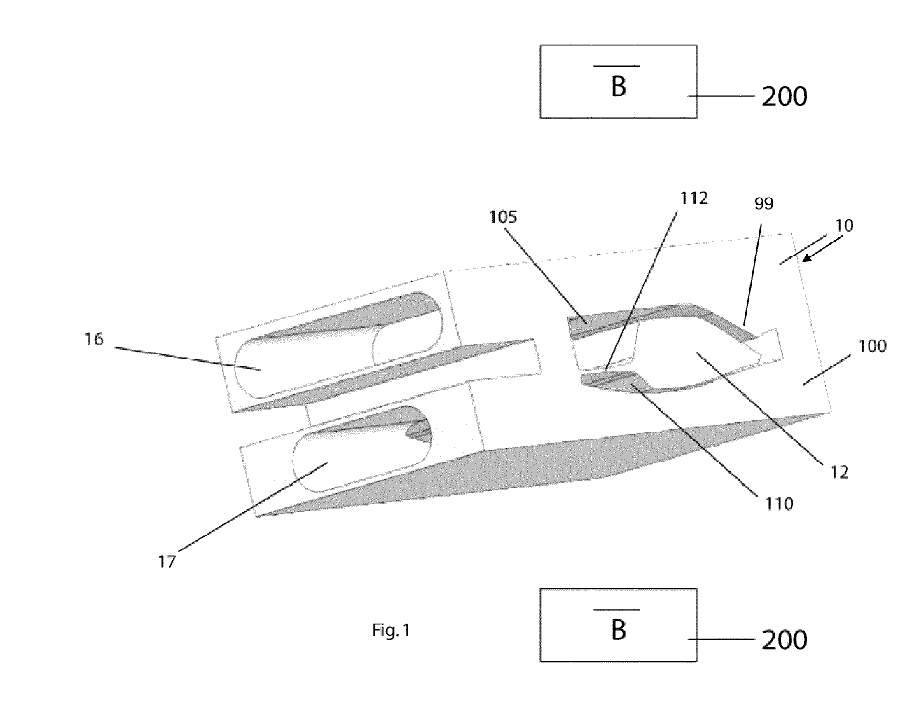

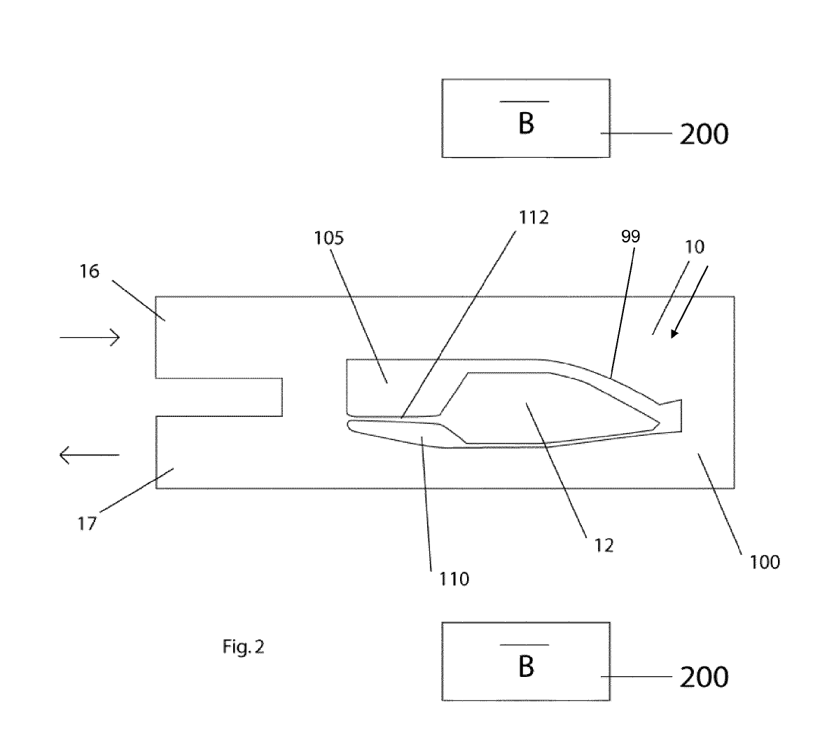

The present invention aims, according to one particular aspect of the invention, to propose a simple embodiment as shown in FIGS. 1 and 2, which makes it possible to produce a valve 10, and in particular a micro-valve, in a single-piece form. In fact, the proposed design is marked by the presence of one or more flaps 12 making it possible to open or close (obstruct) the inlet or intake 16 and/or the outlet or delivery port 17 at least partially. In particular, the valve 10 shown in the figures has a single flap 12 that alternates between performing the opening/closing functions of the inlet (16) and outlet 17. The single flap is mounted in a single chamber 99 enclosed by the body of the valve 10. This single flap constitutes the moving element and is made in the same functional block, and is secured directly to the enclosure or body 100 of said valve. Advantageously, this will therefore be done without the presence or use of outside physical securing means (pivot or hinge) or chemical means (glue or welding).

The connection integrated between the body or the enclosure 100 of said valve and said flap 12 is done by means of an integrated connecting means or part 112 for connecting to said body or enclosure 100 of the valve, making it possible to ensure sufficient flexibility so as to allow said flap 12 to move under the influence of an outside electromagnetic force 200, ‘outside’ meaning ‘applied outside the enclosure 100’. It is thus important for the nature as well as the mass of the moving element(s) to be sufficient to be subjected to the influence of the electromagnetic force. In the embodiment of FIGS. 1 and 2, the fluid passes from the inlet 16 first to an intake chamber 105, and the fluid passes from the chamber 99 first to an outlet chamber 110, before being delivered to the outlet 17.

As seen in the drawings, the flap 12 is shaped as a larger volume 12 attached to the body 100 of the valve via a thin articulation 112. The shape of the outer surfaces of said volume 12 corresponds to the shape of the enclosure's inner surfaces facing said outer surfaces, so that the passage between the outer surfaces of the volume 12 and the inner surfaces of the enclosure may be blocked or narrowed by movement of the flap 12, said movement being actuated by an electromagnetic force. The flap 12, the articulation 112 and the valve body 100 are formed of a ferro-magnetic metal.

As shown in FIGS. 1 and 2, the integrated connecting means, i.e. the articulation 112, may assume the form of a circular notch defined by a very small thickness in light of the radius. The general theory of the circular notch is known as such, for example from ‘Le col circulaire comme articulation flexible’, P. Merken et al, 6th National Congress on Theoretical and Applied Mechanics, Ghent, May 26-27, 2003, NCTAM-2003-078.

A second object of the invention relates to micro-pumps whereof the general operating principle consists of using the movement of an actuator that may assume the form of a membrane or a rigid element within a chamber or reservoir. In the latter case, it is often called the piston or actuator.

Typically, a rigid element will be chosen and for example may assume the form of a central fin or strip that makes it possible, through its movement, to create a vacuum or overpressure in a chamber part, thereby making it possible to take in the fluid through a first port during a first half-cycle and to expel (i.e. deliver) it during the following half-cycle through another port.

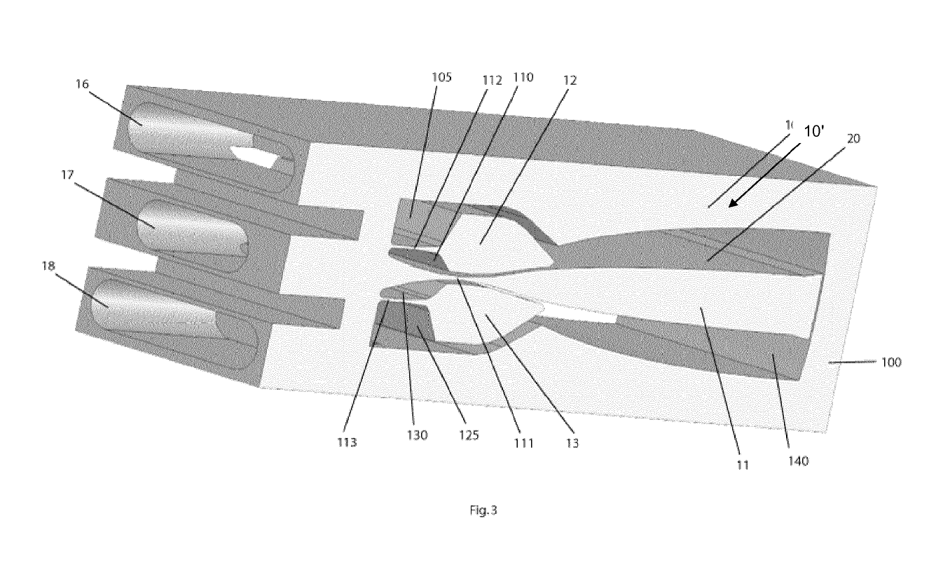

The example embodiments shown in FIGS. 3, 4 and 5 describe a pump, and in particular a micro-pump 10′ with two main chambers (120) and (140) separated by an actuator in the form of a fin (11) that moves between those chambers and, through its movement, alternates between creating an overpressure in one of the two chambers and a vacuum in the other. The creation of an overpressure in the main chamber (120 or 140) thus makes it possible to deliver the fluid toward the outlet (17) by means of one or more outlet chambers (110 or 130), while the creation of a vacuum in the main chamber (120 or 140) allows the intake of the fluid within that chamber by means of the intake chambers (105 or 125).

Particularly simply, the fluid is brought by one or more inlets (16 or 18) within a first or several intake chambers (105 or 125). The passage of the fluid from the inlet (16 or 18) is therefore done by means of the intake chamber (105 or 125) toward the main chamber (120 or 140). This transfer toward the main chamber (120 or 140) is done by appropriate placement of the flap (12 or 13) allowing, by opening, the passage toward said main chamber (120 or 140). The delivery of the fluid toward the outlet (17) is done by means of an outlet chamber (110 or 130). This movement is done by appropriate placement of the flap (12 or 13), which, by opening, allows the passage toward the outlet chamber while simultaneously allowing the closing of the passage from the intake chamber toward the main chamber (120 or 140).

Thus, the passage from the main chamber (120) (or the main chamber 140) toward the outlet chambers (110 and/or 130) is made possible by the inverse (i.e. inverse with respect to the previous sentence) opening/closing movement of a flap (12 or 13). Preferably, it is the same flap (12 or 13) that performs the closing movement of the intake chamber (105 or 125) toward the main chamber (120 or 140). Particularly ideally, it is the same flap that alternates between performing the two functions of opening and closing at the outlet and closing and opening at the inlet.

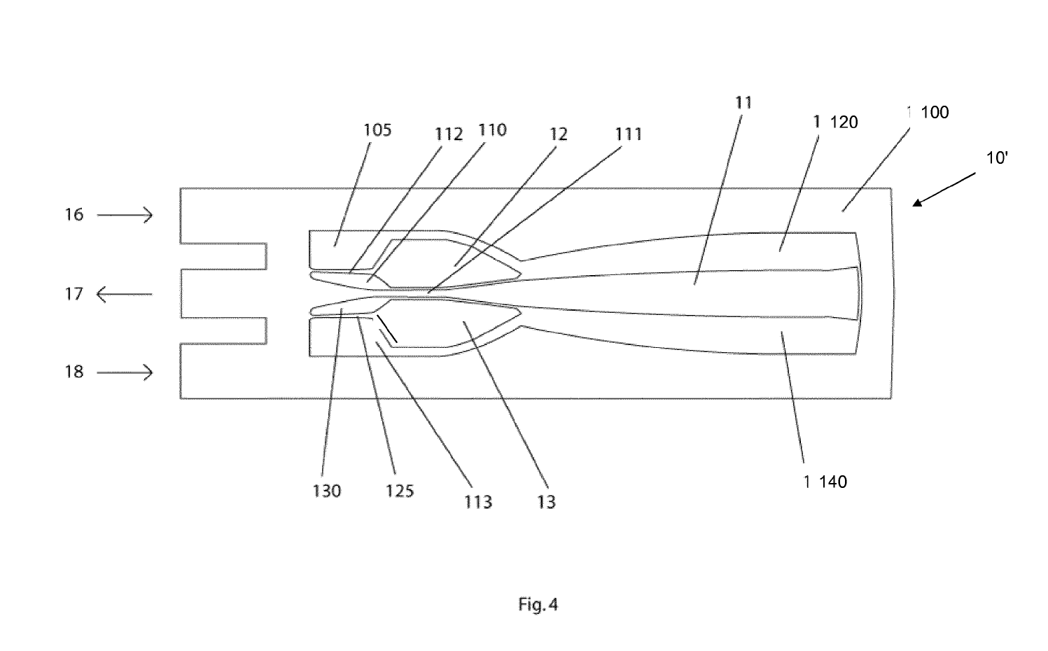

The intake chambers (105,125) and the outlet chambers (110,130) are present in the embodiment shown in FIGS. 3 and 4. However in other designs according to the invention, such separate intake and outlet chambers may be absent or may be indistinguishable from larger inlet our outlet areas within the device.

The above paragraphs related to a (micro)pump according to the invention can be summarized as follows:
a first moveable element 12 is configured to open and close the first inlet 16 and the outlet 17 cyclically,
a second moveable element 13 is configured to open and close the second inlet 18 and the outlet 17 cyclically,
a moveable actuator element 11 is provided, acting as a piston, made from a ferromagnetic metallic material, and arranged to separate a first and second main chamber (120,140) within the enclosure 100, the actuator element being arranged between the first and second moveable element (12,13), so that cyclic movement of the piston element 11 between the first and second main chamber (120,140) causes the simultaneous intake of fluid through the first or second inlet (16,18), and delivery of fluid through the outlet 17.

Opening and closing of the inlets 16/18 is established by opening and closing the passage between the moveable elements 12/13 and the inner surface of the enclosure 100 of the pump. The surfaces of the moveable elements 12/13 and the inner surfaces of the enclosure 100 that are facing each other across said passages are corresponding in shape so that the passages may be closed off by moving the moveable elements.

Opening and closing of the outlet 17 is established by opening and closing the passage between the moveable elements 12/13 and the outer surface of centrally placed actuator element 11. The surfaces of the moveable elements 12/13 and the outer surfaces of the actuator element 11 that are facing each other across said passages are corresponding in shape so that the passages may be closed off by moving the moveable elements 12/13 and/or the actuator element 11.

Advantageously, both the actuator 11, preferably in the form of a fin, and each of the flaps (12, 13) are directly secured to the enclosure 100, therefore to the body of the pump.

Advantageously, this securing is done in the very body of the enclosure 100 and is done by means of the connecting means or part integrated into the pump body, making it possible to impart sufficient flexibility so as to allow said flaps (12 and 13) (and/or the actuator 11) to move under the influence of an outside electromagnetic force.

As shown in FIGS. 3 and 4, this integrated connecting means or part assumes the form of a circular notch (112, 113, 111) defined by a very small thickness in light of the radius.

Advantageously, to make the articulation (circular notch) more flexible, but also to allow the moving elements, such as the flaps and/or actuator in the case of a micro-valve or micro-pump, to be subjected to electromagnetic force, it has been proposed to increase the volume of said moving elements. Likewise, the length of the articulation (integrated connecting part) is increased so as to maximize the momentum of the forces applied on the flaps and the central fin by the electromagnet. Nevertheless, this must be a compromise between the fatigue strength and the influence caused by the electromagnets.

Ideally, the theory of the circular notch proposes:

$$α = \frac{3 π}{4} \frac{σ}{E} \sqrt{\frac{R}{{h}_{0}}}$$

### Where:

α=the maximum angle in radians
σ=the maximum strain applicable to the material to remain within the yield strength
E=the Young's modulus of the material
R=the radius of the notch
H₀=the thickness of the notch.

According to the parameters chosen for the notches, i.e.:

### σ=500 N/mm²

### E=203,000 N/mm²

### R=10 mm

### H₀=80 μm

The admissible angle α is therefore 0.078 rad, i.e., 4.47°.

In producing micro-valves or micro-pumps according to the invention, the ability to avoid any physical or mechanical securing means advantageously makes it possible to avoid any lubrication. Likewise, the securing being done without chemical means, it has thus been observed that particularly advantageously, this type of pump may be used for sterile applications.

By using very precise cutting techniques, and in particular spark machining techniques, it is possible to produce and machine, in electrically conducting materials, elements having very small dimensions, and in particular thicknesses which are preferably smaller than 50 μm but may reach dimensions smaller than 30, 20 or even 10 μm for gaps preferably below 50 μm and preferably below 30 or 20 μm with allowances lower than 1 μm.

The main difficulty is to propose component parts that still have enough flexibility that they are capable of moving when they are subjected to outside forces, and in particular electromagnetic forces.

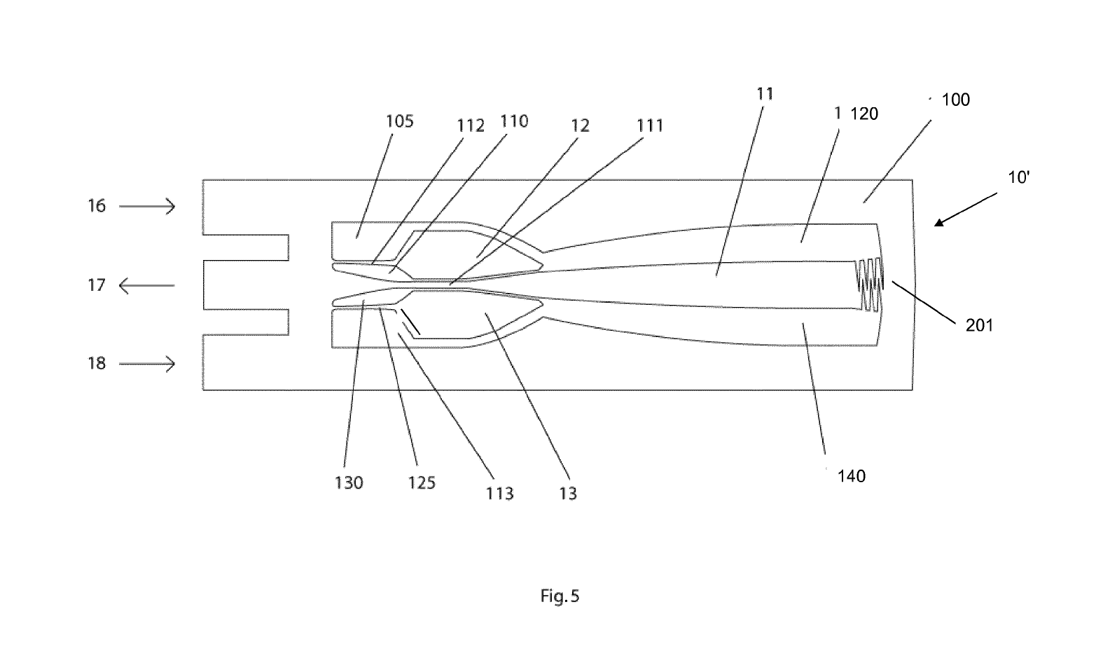

The two main chambers 120/140 in the design of FIGS. 3 and 4 are separated by the actuator 11. In order to be able to build up a pressure in said chambers, the clearance between the distal end of the actuator and the interior of the enclosure needs to be minimal. Nevertheless, said clearance represents a small pressure loss. According to another embodiment illustrated in FIG. 5, it is possible to consider that the two main chambers 120/140 are sealed or practically sealed relative to one another by adding a second integrated connection means in the form of a part of the actuator assuming the form of a spring 201 as shown in FIG. 5 (zigzag created in the mass of the actuator). The spring 201 is integral with the actuator 11 and with the enclosure 100. The spring 201 allows the movement of the actuator 11 whilst ensuring complete separation of the main chambers 102 and 140.

The two embodiments respectively shown in FIGS. 3 and 4 on the one hand and FIG. 5 on the other hand are examples of pumps with two chambers, but of course any design may be proposed. In particular, pumps with one, three, four, or more chambers may of course be proposed.

This configuration will be particularly advantageous in the case where one wishes to produce dosing pumps, and in particular in the case where the volume of each of the main chambers is calculated so as to perform a proportional function in the final mixing. As an example, it is possible to consider a design in which the first main chamber produces 30% of the volume, while the second main chamber produces 70% of the volume. In that scenario, we will obtain a 30/70 dosing pump. One skilled in the art may of course consider any other design form or specific configuration.

Another particularly interesting advantage of this type of pump lies in the fact that no mechanical or chemical securing means are provided to connect the moving elements to the enclosure of said pump. This also makes it possible for no pollution to occur in the metering. In particular, the use of this type of pump will be particularly recommended in sterile settings, such as medical settings, or intended to manufacture components that must be kept sterile all throughout their mixing.

1. A device comprising a body or an enclosure (100) constituting at least one chamber (99, 120, 140) with at least one fluid inlet (16 or 18) and at least one fluid outlet (17), said device comprising at least one moveable element serving as a flap (12 or 13) and making it possible to open and close at least one of the inlet and outlet cyclically, the moveable element being made from a ferromagnetic metallic material, characterized in that:
said moveable element (12 or 13) is integral with at least one part of the body or enclosure (10) that forms the chamber of said device,
the nature and the mass of the moveable element are such that the moveable element can be subjected to a movement under the action of an outside electromagnetic force, to thereby close/open at least one of the inlet and outlet,
the device comprises an integrated connecting means (112) for connecting the moveable element to said body or enclosure (100), making it possible to ensure sufficient flexibility so as to allow said moveable element (12) to move under the influence of said outside force, to thereby close/open the at least one of the inlet and outlet.

2. The device according to claim 1, characterized in that the integrated connecting element (112) is in the shape of a circular notch.

3. The device according to claim 1, characterized in that the body or the enclosure (100) of the device and said moveable element (12) are made in a single piece.

4. The device according to claim 1, wherein said device is a valve (10) comprising an inlet (16) and an outlet (17), and a moveable element (12) as described in claim 1, configured for regulating the flow of a fluid from the inlet (16) to the outlet (17).

5. The device according to claim 4, wherein said device is a microvalve.

6. The device according to claim 1, wherein the device is a pump, comprising a first inlet (16), a second inlet (18) and an outlet (17), the device further comprising:
said moveable element including a first moveable element (12), configured to open and close the first inlet (16) and the outlet (17) cyclically,
said moveable element including a second moveable element (13) configured to open and close the second inlet (18) and the outlet (17) cyclically,
an moveable actuator element (11), made from a ferromagnetic metallic material, and arranged to separate a first and second main chamber (120,140) within the enclosure (100), the actuator element being arranged between the first and second moveable element (12,13), so that cyclic movement of the actuator element (11) between the first and second main chamber (120,140) causes simultaneously:
the intake of fluid from the first or second inlet (16,18) into one of said main chambers (120,140), and
the delivery of fluid from the other of said main chambers (120, 140) to the outlet (17),
a further integrated connecting means (111) for connecting the actuator element (11) to said body or enclosure (100), making it possible to ensure sufficient flexibility so as to allow said actuator element (11) to move under the influence of the outside electromagnetic force, to thereby take in or deliver the fluid.

7. The device according to claim 6, wherein the device is a micropump.

8. The device according to claim 6, comprising at least one intake chamber (105,125) between at least one of the first and second inlet (16,18) and the first and/or second moveable element (12) and further comprising at least one outlet chamber (110,130) between at least one of the first and the second main chamber (120,140) and the outlet (17).

9. The device according to claim 6, wherein the actuator element (11) assumes the form of an elongated strip or fin.

10. The device according to claim 6, wherein the integrated connecting means (111) for connecting the actuator element (11) to said body or enclosure (100) is in the shape of a circular notch.

11. The device according to claim 6, wherein the actuator element (11) is connected to the enclosure via a second integrated connection means to thereby seal the first and second main chamber from each other.

12. The device according to claim 11, wherein the second connection means is formed as spring (201).

13. The device according to claim 1, wherein said device is an integral piece obtainable by spark machining.

14. The device according to claim 1, characterized in that it has at least two separate chambers so as to be able to produce a mixing or metering pump.

15. A use of the device according to claim 1, for medical applications, and in particular sterile applications.
